(19) United States
(12) Patent Application Publication
(10) Pub. No.: US 2011/0305842 A1
(43) Pub. Date: Dec. 15, 2011

(54) FLOATABLE OPPOSABLES FOR APPLYING FLUIDS TO PROCESS BIOLOGICAL SAMPLES

(75) Inventor: Brian Howard Kram, Tucson, AZ (US)

(73) Assignee: Ventana Medical Systems, Inc., Tucson, AZ (US)

(21) Appl. No.: 13/157,231

(22) Filed: Jun. 9, 2011

Related U.S. Application Data
(60) Provisional application No. 61/354,144, filed on Jun. 11, 2010.

(51) Int. Cl. B05D 3/12; B05C 9/14; B05C 9/12; B05D 7/00; B05C 11/00

(52) U.S. Cl. 427/355; 118/71; 118/33; 118/696; 118/58

(57) ABSTRACT

A slide processing apparatus is used to apply substances for processing specimens. The slide processing apparatus can deliver a substance to a mounting surface of a slide carrying the specimen. The substance can be contacted with an opposable held by an opposable holder device. The opposable is pulled towards the slide by the substance. The substance can spread along the mounting surface as the opposable is flattened. If the substance is a liquid, the opposable can float on the liquid to form a thin liquid layer.

### CROSS-REFERENCE TO RELATED APPLICATION

This application claims the benefit under 35 U.S.C. §119(e) of U.S. Provisional Patent Application No. 61/354,144 filed Jun. 11, 2010, where this provisional application is incorporated herein by reference in its entirety.

### BACKGROUND

1. Technical Field

The present invention relates generally to slide processing apparatuses with floatable opposables used to process specimens. More specifically, the invention is related to slide processing apparatuses that float opposables on fluids to process biological samples.

2. Description of the Related Art

A wide variety of techniques have been developed to prepare and analyze biological samples. Example techniques include microscopy, micro-array analyses (e.g., protein and nucleic acid micro-array analyses), and mass spectrometric methods. Microscope slides bearing biological samples, e.g., tissue sections or cells, are often treated with one or more dyes or reagents to add color and contrast to otherwise transparent or invisible cells or cell components. Samples can be prepared for analysis by manually immersing sample-bearing slides in containers of dyes or other reagents. This labor intensive process often results in inconsistent processing and carryover of liquids between containers. Carryover of liquids leads to contamination and degradation of the processing liquids. These types of processes often utilize excessive volumes of liquids resulting in relatively high processing costs, especially if the dyes or other reagents are expensive and are prone to degradation due to carryover.

“Dip and dunk” automated machines immerse samples in liquids similar to manual immersing techniques. These automated machines can process samples in batches by submerging racks carrying microscope slides in open baths. Unfortunately, relatively large amounts of reagents are in bath containers of the dip and dunk automated machines. Similar to manual processes, if the liquids are expensive reagents, processing costs may be relatively high, especially if significant amounts of reagents are wasted. Reagent bath containers may be frequently emptied because of contamination due to carryover. Open containers are also prone to evaporative losses that may significantly alter the concentration of the reagents resulting in inconsistent processing. It may also be difficult to process samples without producing significant volumes of waste that may require special handling and disposal.

### BRIEF SUMMARY

At least some embodiments disclosed herein are directed to a slide processing apparatus that uses an opposable to apply a substance to a specimen carried on a microscope slide. When the opposable is brought into contact with the substance (e.g., a fluid), capillary forces pull the opposable towards the slide to distribute the substance across a mounting region of the slide. The opposable can freely float on the substance. The opposable keeps the substance spread along the mounting region without damaging the specimen due to, for example, excessive compression. Floating the opposable can also minimize or avoid over-filling and/or under-filling. By preventing over-filling and under-filling, different types of fluidic failure modes (e.g., reagent performance degradation), reagent waste, or the like can be mitigated or avoided.

The slide processing apparatus can use an opposable to manage any number of substances to perform a protocol. Managing substances can include, without limitation, spreading substances to form thin layers, moving a bolus of substances, or otherwise manipulating substances to process samples on slides. The opposable can be removed after processing. Alternatively, the opposable can coverslip the slide. Adhesives, mounting fluids, or other mounting substances can be used to coverslip the slide with the opposable.

In some other embodiments, an opposable holder device is configured to place an opposable on a liquid carried on a slide. The opposable floats to maintain a liquid layer on the slide without damaging a specimen. To place the opposable on the liquid, the opposable holder device can release the opposable to allow flattening of the opposable. As the opposable moves towards a flattened configuration, the liquid fills a capillary gap between the opposable and the slide. The opposable can assume different configurations (e.g., a non-planar configuration, a planar configuration, etc.) to manage the liquid.

The opposable, in some embodiments, is resilient. In certain embodiments, the opposable has a non-planar configuration, such as an arcuate configuration, in a relaxed state. The opposable can be moved away from the non-planar configuration to cover the slide. In other embodiments, the opposable has a generally planar configuration in a relaxed state. The opposable holder device can pull the opposable to a deflected state in which the opposable has a curved configuration. The opposable can return to the generally planar configuration when released. The internal resiliency of the opposable, tensioners, capillary forces, or the like can be used to move the opposable to different configurations.

In some embodiments, a staining instrument includes one or more slide processing apparatuses. Each slide processing apparatus can move an opposable using forces provided by a liquid (e.g., capillary forces provided by a stain), an opposable holder device, or both. If the opposable is a drapable membrane, capillary forces alone can move (e.g., flatten) the opposable. If the opposable is a rigid element, the opposable holder device can include a platen that bends or otherwise reconfigures the opposable.

An operator may manually load the opposable into the staining instrument. The opposable can be anchored to the platen by, for example, inserting an end of the opposable into a slot or other anchoring feature that captivates the end. In some embodiments, a tensioner is coupled to the opposable by inserting a hook into an aperture (e.g., a pre-cut hole) in the opposable. The tensioner can tension and move the opposable.

In yet other embodiments, a method of applying a liquid to a specimen on a slide includes delivering a liquid onto a slide carrying a specimen and/or an opposable. The opposable is held in a non-planar configuration and is spaced apart from the slide using an opposable holder device. The liquid is contacted by the slide and the opposable. The liquid is allowed to move at least a portion of the opposable away from the non-planar configuration towards a substantially planar configuration to spread the liquid between the slide and opposable. The opposable floats on the liquid to keep the liquid spread the slide. In certain embodiments, the spread liquid can have a substantially uniform thickness or a varying thickness. If the floating opposable has a generally planar configuration, the spread liquid layer can have a generally uniform thickness. If the floating opposable has a non-planar configuration, the liquid can have a variable thickness.

The opposable, in some embodiments, can freely float on the liquid. The opposable can drift along the liquid to easily reposition the opposable with respect to the specimen. The opposable, in some embodiments, is supported only by the liquid. For example, the entire opposable can be held above both the specimen and the microscope slide. The opposable can be applied to the slide without pressing the opposable against the slide and/or the specimen.

In some other embodiments, a method includes contacting a liquid with an opposable in a non-planar configuration. At least a portion of the opposable is flattened using capillary forces. The liquid is spread along the slide as the opposable is flattened. Spreading the liquid, in one embodiment, may include pushing the liquid along a mounting surface of the slide, pulling the liquid along the mounting surface, flowing the liquid along a capillary gap, or combinations thereof. The flattened opposable, in certain embodiments, can freely float on the spread liquid. As such, the opposable can be capable of relatively unrestricted motion with respect to the slide. The opposable can continue to float on the liquid even if the volume of liquid is reduced (e.g., via evaporation).

In yet a further embodiment, an apparatus comprises a slide holder and an opposable holder device. The opposable holder device is configured to hold an opposable. The opposable holder device in a first position holds the opposable in a non-planar configuration while the opposable (e.g., the entire opposable) is spaced apart from a slide held by the slide holder. The opposable holder device in a second position contacts at least a portion of the opposable with a liquid on the slide to move the liquid.

In further embodiments, a slide processing apparatus includes a slide holder and an opposable holder device. The opposable holder device holds an opposable in a non-planar configuration. In a first state of operation, the opposable holder device moves towards the slide holder to contact a liquid with a surface of a slide and with the opposable held by the opposable holder device. In a second state of operation, the opposable holder device allows the liquid contacting the opposable to move at least a portion of the opposable away from the non-planar configuration towards a substantially planar configuration to spread the liquid. The opposable holder device selectively releases the opposable to float the opposable on the liquid.

In some embodiments, a slide processing apparatus can be used to spread a liquid using a curved opposable held by a platen such that the opposable does not physically contact or apply significant forces to a microscope slide as the liquid is spread along most or substantially all of the opposable. In certain embodiments, the entire opposable can be spaced apart from the microscope slide throughout most or substantially all of the spreading process. The opposable can also assume different configurations without physically contacting the microscope slide. The opposable, for example, can float on the liquid without any significant physical interaction between the opposable and the microscope slide. Adhesion forces provided by the liquid keep the opposable in a flat configuration.

A controller may be communicatively coupled to the opposable holder device. The controller sends one or more signals to an actuator, tensioner, or other component of the opposable holder device. In some embodiments, the opposable holder device move the opposable towards the slide to spread the liquid without deforming the opposable due to physical contact between the slide and the opposable in response to signals from the controller.

The slide processing apparatus, in some embodiments, is capable of complex movement of a platen carrying the opposable. Tensioners, pneumatic systems, or the like can be used to hold the opposable against the platen. In some embodiments, a tensioner has a hook that is coupled to the opposable. A tether can extend from the hook to a pulling unit of the tensioner. The pulling unit can apply tension to the tether to pull the opposable against the platen. A substantial portion of the opposable may be kept in a substantially flat configuration when capillary forces are equilibrated. For example, at least 80% of a lower surface of the opposable can be generally flat. In certain embodiments, substantially the entire opposable is held in the substantially flat configuration to inhibit, minimize, or substantially eliminate evaporative losses, thereby reducing the volume of liquid needed to process a specimen. The opposable may also provide enhanced enchambering effect.

In some other embodiments, a controller is communicatively coupled to an opposable holder device. The controller sends signals to the opposable holder device to have the opposable holder device move an opposable towards the slide to spread the liquid without deforming the opposable due to physical contact between a slide and the opposable. In some embodiments, the liquid is spread without deforming the opposable to any significant extent due to physical contact between the slide and the opposable.

A method comprises contacting a liquid with a slide and an opposable carried by a roller mechanism. The opposable is rolled to manipulate (e.g., spread) the liquid. The opposable is allowed to move from a first configuration to a second configuration using the liquid. At least a portion of the opposable in the second configuration floats on the liquid. In certain embodiments, most or all of the opposable can be spaced apart from the slide and/or specimen as the opposable is rolled. In other embodiments, the opposable physically contacts the slide and/or specimen as it is rolled.

The roller mechanism, in some embodiments, includes an actuator that moves a platen carrying the opposable. The actuator includes one or more bearings, pivot mechanisms, pistons, drive motors, combinations thereof, or the like. In some embodiments, the actuator rolls, rotates, and/or translates the platen.

In yet further embodiments, a method comprises contacting a liquid with an opposable and a slide carrying a specimen while at least a substantial portion of the opposable is spaced apart from the liquid. A first portion of the opposable floats on the liquid. A second portion of the opposable is flattened using a roller mechanism. The flattened portion can float on the liquid. In certain embodiments, most of the length of the opposable (e.g., longitudinal length) cooperates with the slide to form a thin liquid layer.

An opposable, in some embodiments, includes a field of gapping elements. The gapping elements can be evenly or unevenly distributed across a surface of the opposable to define different patterns, including, without limitation, one or more rows, arrays, geometric shapes, or the like. The gapping elements can position of the surface of the opposable with respect to the slide. The opposable can have a relatively large number of gapping elements, rows of gapping elements, etc. to distribute the contacting load so as to minimize or limit loading (e.g., pressure point loading) to the specimen. Such embodiments may have gapping elements positioned to contact the specimen during use.

### BRIEF DESCRIPTION OF THE SEVERAL VIEWS OF THE DRAWINGS

Non-limiting and non-exhaustive embodiments are described with reference to the following drawings. The same reference numerals refer to like parts or acts throughout the various views, unless otherwise specified.

FIG. 1 is a side elevational view of a slide processing apparatus in an open position with an opposable spaced apart from a microscope slide.

FIG. 2 is a side elevational view of the slide processing apparatus of FIG. 1 contacting a liquid with the opposable.

FIG. 3 is a side elevational view of the opposable floating on a liquid layer.

FIG. 4 is a side elevational view of a slide processing apparatus holding a microscope slide at an inclined position.

FIG. 5 is an elevational view of liquid on the slide of FIG. 4 taken along a line 5-5.

FIG. 6 is a side elevational view of the slide processing apparatus of FIG. 4 with an opposable forming a liquid layer.

FIG. 7 is an elevational view of the liquid layer on the slide of FIG. 6 taken along a line 7-7.

FIG. 8 is a side elevational view of the opposable spaced apart from the slide.

FIG. 9 is a side elevational view of the opposable moved away from the slide to allow removal of the liquid.

FIG. 10 is an isometric view of an opposable holder device, in accordance with one embodiment.

FIG. 11 is a cross-sectional view of the opposable holder device of FIG. 10 taken along a line 11-11.

FIG. 12 is a bottom view of the opposable holder device of FIG. 10.

FIG. 13 is a side elevational view of a slide processing apparatus in an open position with an opposable carrying a substance to be applied to a specimen.

FIG. 14 is a side elevational view of the slide processing apparatus of FIG. 13 with the substance contacting a microscope slide and the opposable.

FIG. 15 is a side elevational view of the opposable of FIG. 14 floating on a liquid layer.

FIG. 16 is a side elevational view of a slide processing apparatus with an opposable spaced apart from a microscope slide carrying a specimen and a fluid.

FIG. 17 is a side elevational view of the slide processing apparatus of FIG. 16 with the fluid trapped between the opposable and the microscope slide.

FIG. 18 is a side elevational view of a slide processing apparatus that traps a bolus of fluid at one end of the opposable.

FIG. 19 is a side elevational view of the slide processing apparatus with the bolus of fluid at another end of the opposable.

FIG. 20 is an elevational view of the slide processing apparatus with a platen spaced apart from the floating opposable.

FIG. 20A is a detailed view of a portion of the opposable of FIG. 20.

FIG. 21 is a bottom view of an opposable, in accordance with one embodiment.

FIG. 22 is a side elevational view of a slide processing apparatus with an opposable trapping a fluid.

FIG. 23 is a side elevational view of the slide processing apparatus of FIG. 22 spreading the fluid.

FIG. 24 is a side elevational view of the slide processing apparatus of FIG. 22 with the opposable forming a fluid layer.

### DETAILED DESCRIPTION

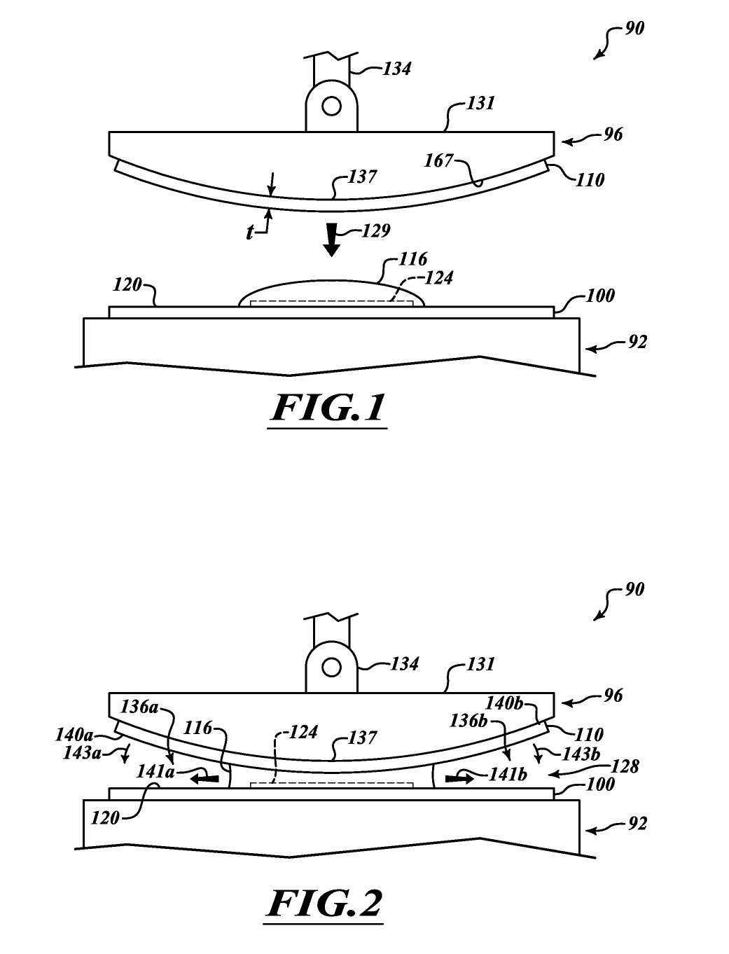

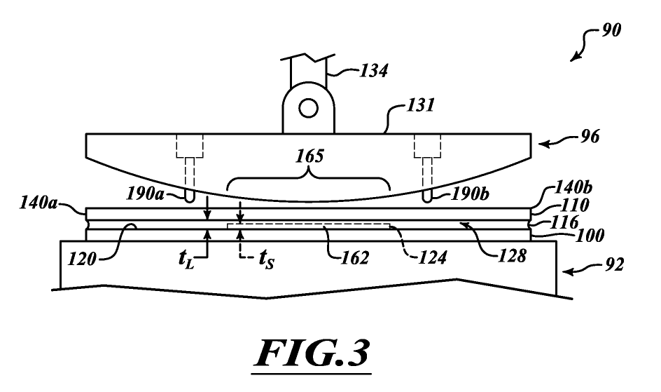

FIGS. 1-3 show a slide processing apparatus 90 including a slide holder 92 and an opposable holder device 96. The slide holder 92 carries a slide 100. The opposable holder device 96 carries an opposable 110 that faces the slide 100. To process to a specimen 124 (illustrated in dashed line), a liquid 116 is delivered onto an upper surface 120 of the slide 100. The slide processing apparatus 90 moves from an open position (FIG. 1) to a closed position (FIG. 2) to move the opposable 110 into contact with the liquid 116. Different types of forces can help move the opposable 110 towards a flattened configuration. Capillary forces provided by the liquid 116 can help move the opposable 110 towards the illustrated flattened configuration. Ejection forces for releasing the opposable 110 can affect how the opposable flattens, floats, or interacts with the liquid 116. As the opposable 110 flattens, it spreads the liquid 116 along the upper surface 120. The opposable holder device 96 is separated from the opposable 110 to float the opposable 110 on a thin layer liquid 116 in contact with the specimen 124, as shown in FIG. 3.

Referring to FIG. 1, the opposable holder device 96 generally includes a platen 131 and an actuator 134. The platen 131 can have a lower surface 167 with a shape generally corresponding to the desired shape of the retained opposable 110. The platen 221 can be, without limitation, a mechanical chuck, a vacuum chuck, or an electrostatic chuck. A mechanical chuck can include one or more clamps, adhesive layers, mechanical fasteners, or the like capable of selectively holding and releasing the opposable 110. Other types of platens can also be used.

The actuator 134 can include, without limitation, one or more drives (e.g., linear drives, reciprocating drives, or the like), motors (e.g., stepper motors, drive motors, or the like), solenoids, piston assemblies, gear trains, combinations thereof, or other electronically, mechanically, hydraulically, or pneumatically driven components capable of cooperating to move the platen 131. The actuator 134 can be configured to rock, roll, translate, vibrate, or otherwise move the platen 131 to manipulate the liquid 116.

The slide holder 92 can include one or more mechanical clamps, retainers, or other types of features that can fixedly hold the slide 100. In some embodiments, the slide holder 92 is in the form of a chuck, such as an electrostatic chuck, pneumatic chuck, or the like. The slide holder 92 can hold the slide 100 stationary even if significant forces are applied to the slide 100.

FIGS. 1 and 2 show the opposable 110 in an arcuate configuration. Forces (e.g., capillary forces) provided by the liquid 116 deflect the opposable 110 from the curved configuration towards a substantially planar configuration. When the opposable 110 is in the substantially planar configuration, most of the opposable 100 is contacted and supported by the liquid 116.

As used herein, the term “opposable” is a broad term and includes, but is not limited to, a coverslip, a strip of material, a sheet, a membrane, a flexible tile, a flexible member, or other floatable member. Opposables can be resilient. In one resilient embodiment, the opposable, in a relaxed state, can have a non-planar configuration. The opposable moved to another configuration, such as a planar configuration. The inherent resiliency of the opposable can cause the opposable to fully recover its original shape. The non-planar configuration can be an arcuate configuration, including a curved configuration, a partially circular configuration, a partially elliptical configuration, or the like. Non-planar configurations also include W-shaped configurations, V-shaped configurations, corrugated configurations, or the like. In other resilient embodiments, the opposable, in a relaxed state, can be in a generally planar configuration. The opposable can be deflected from the planar configuration using a tensioner or other device. When released, the opposable can return to the planar configuration to, for example, cover a specimen. In non-resilient embodiments, the opposable 110 can be a flexible sheet that is movable between a wide range of different configurations. For example, the non-resilient opposable 110 can be a relatively thin sheet made of a highly compliant material, such as a drapable material. The platen 131 can hold the highly compliant opposable 110 in the illustrated arcuate configuration using minimal forces.

The opposable 110 can be made, in whole or in part, of one or more metals, polymers, plastics, composites, glass, combinations thereof, or other suitable materials that may be generally rigid, semi-rigid, resilient, semi-compliant, or compliant. The opposable 110 can have a monolayer or multi-layer construction. One highly compliant opposable 110 is in the form of a metal foil sheet. The metal foil sheet can readily float on a wide range of different types of liquids 116 due to surface tension. In certain embodiments, the opposable 110 is in the form of a drapable element (e.g., a sheet, a membrane, or the like). Drapable membranes can be impermeable, semi-permeable, or permeable to the processing liquid or other substances. Resilient opposables can be made, in whole or in part, of one or more polymers, such as polyester, polyethylene terephthalate, rubber, polyvinylidene fluoride, polytetrafluoroethylene, polyethylene (PE), polypropylene (PP), polycarbonate, or combinations thereof. The composition of the opposable 110 can be selected based on desired characteristics, including, without limitation, optical characteristics, surface energy, flexibility, wettability, chemical compatibility, or the like. In some embodiments, for example, the slide 100 and opposable 110 are made of a hydrophobic material to ensure sufficient containment of the liquid 116.

The opposable 110 can be configured to overlay most or substantially the entire specimen 124. In some embodiments, the opposable 110 has at least one dimension that is greater than a corresponding dimension of the slide 100. Additionally or alternatively, the opposable 110 can have at least one dimension that is less than a corresponding dimension of the slide 100. The opposable 110 can thus be oversized and/or undersized with respect to the slide 100 to ensure that the liquid 116 is properly contained. If the slide 100 is a standard microscope slide, the opposable 110 can have a length in a range of about 0.5 inch (13 mm) to about 3 inches (76 mm), a width in a range of about 0.5 inch (13 mm) to about 1 inch (25.5 mm), and a thickness in a range of about 0.001 inch (0.025 mm) to about 0.08 inch (2 mm). In some embodiments, the opposable 110 has a length of about 50 mm, a width of about 24 mm, and a thickness of about 0.1 mm to about 0.4 mm. The opposable 110, as viewed from above, can have a generally polygonal shape (e.g., a square shape, a rectangular shape, or the like), an elliptical shape, or a circular shape. The dimensions and configuration of the opposable can be selected based on the processing protocol to be performed. For example, the thickness t (see FIG. 1) of the opposable 110 can be decreased or increased to decrease or increase the forces needed to reconfigure (e.g., deform, deflect, etc.) the opposable 110.

The slide 100 can be a 1 inch×3 inch microscope slide, a 25 mm×75 mm microscope slide, or other type of slide or substrate for holding specimen(s) for examination using equipment, such as optical equipment, e.g., a microscope or other optical device. The slide 100 can be a substantially flat substrate. “Substantially flat substrate” refers, without limitation, to any object having at least one substantially flat surface, but more typically to any object having two substantially flat surfaces on opposite sides of the object, and even more typically to any object having opposed substantially flat surfaces, which opposed surfaces are generally equal in size but larger than any other surfaces on the object. A substantially flat substrate can be formed of any suitable material, including glass, silicon, a semiconductor material, metal, combinations thereof, or the like. Non-limiting examples of substantially flat substrates include slides (both 1 inch×3 inch microscope slides and 25 mm×75 mm microscope slides), SELDI and MALDI chips, silicon wafers, or other generally planar objects with at least one substantially flat surface. Other types of specimen carriers can also be used with the slide processing system. The slide 120 can include a label including machine-readable code (such as a one- or multi-dimensional barcode or infoglyph, an RFID tag, a Bragg-diffraction grating, a magnetic stripe or a nanobarcode) with coded instructions that specify the type, sequence, timing of the liquid(s) delivered for treatment of a particular specimen, or the like.

The slide processing apparatus 90 of FIGS. 1-3 can perform different tissue preparation processes and mounting processes. Tissue preparation processes can include, without limitation, deparaffinizing a specimen, conditioning a specimen, staining a specimen, performing antigen retrieval, performing immunohistochemistry (IHC), and/or performing in situ hybridization (ISH), as well as other processes for preparing specimens for microscopy, micro-analyses, mass spectrometric methods, or the like. If the specimen is a sample embedded in paraffin, the sample can be deparaffinized using appropriate deparaffinizing fluid(s). After removing the deparaffinizing fluid(s), any number of reagents can be successively applied to the specimen. The slide 100 can then be coverslipped by the slide processing apparatus 90. Mounting processes include, without limitation, wet mounting slides, permanently mounting slides, or otherwise covering the sample.

Processing liquids can be efficiently applied to the specimen 124 to minimize or limit the cost of processing liquid(s) and to minimize or limit the amount of waste liquid. Optimized liquid volumes can be used to minimize or avoid problems with excessive volume consumption, including high processing costs, as well as avoiding over-wetting and/or under-wetting. Optimized liquid volumes can also be used to increase efficiency and reduce cost as compared to fixed volume processing (i.e., processing that only uses a constant volume of liquid for each liquid application). Different volumes of processing liquids can be applied using opposables of different sizes. The reduction of costs may be based on the reduction of the consumed liquid volumes, as well as the reduction of system costs by reducing or avoiding relatively high costs associated with high liquid volume consumption, including manufacturing costs, packaging costs, transportation costs, customer workflow handling costs (e.g., handling cost for incoming inventory as well as outgoing waste management), and fluidic management overhead costs. Dispensing of excessive liquid volumes may also lead to malfunctions (e.g., clogging, leaking, or the like) of fluidic components and may require frequent recalibration of equipment. The slide processing apparatus 90 can minimize or avoid these types of problems.

The specimen 124 can be processed without over-filling or under-filling. Over-filling can occur when the volume of dispensed liquid is greater than the volume of a gap 128 (see FIG. 2). Over-filling can lead to unwanted conditions, including sagging of the liquid 116 and ultimately draining of the liquid 116, especially if the slide 100 is at an inclined or upright orientation. The opposable 110 can float on a wide range of different liquid volumes using surface tension to prevent over-filling. Under-filling may occur when the liquid 116 does not fill most of the gap 128. Under-filling may lead to inadequate contact between the liquid 116 and the specimen 124. Capillary forces can cause the liquid 116 to flow along the gap 128 and minimize or eliminate unfilled gaps 136a, 136b (see FIG. 2).

FIGS. 1-3 show a method of processing the specimen 124. Generally, the liquid 116 can be delivered manually (e.g., using a manual pipette) or automatically (e.g., using a fluid delivery apparatus) onto the slide 100. The actuator 134 moves the opposable 110 towards the slide 100, as indicated by an arrow 129 in FIG. 1. A central region 137 of the opposable 110 nearest the slide 100 is brought into contact with the liquid 116. The opposable 110 is released to spread the liquid 116. The opposable 110 then floats on a thin liquid layer 116 to keep the specimen 124 in contact with the liquid 116. This process is discussed in detail below.

Referring to FIG. 1, the opposable 110 is ready to spread the liquid 116 and is in an arcuate configuration. Arcuate configurations include, without limitation, simple arc configurations, complex arc configurations, compound arc configurations, or the like. The illustrated opposable 110 is in a simple arc configuration with a generally uniform curvature. The radius of curvature can be about 0.5 inch, 5 inches, 20 inches, 25 inches, or ranges encompassing such radii of curvature. Other radii are also possible. If the opposable 110 is in a complex arc configuration, at least a portion of the opposable 110 has a varying curvature. If the opposable 110 is in a compound arc configuration, a portion of the opposable 110 can be in a simple arc configuration and another portion of the opposable 110 can be in a complex arc configuration.

The actuator 134 moves the platen 131 towards the liquid 116. The opposable 110 is brought into contact with the liquid 116 protruding from the upper surface 120. As the opposable 110 continues to move towards the slide 100, the liquid 116 is displaced outwardly away from the central region 137.

FIG. 2 shows ends 140a, 140b (collectively “140”) of the opposable 110 extending away from the slide 100. This helps keep liquid 116 at the narrowest section of the gap 128. The opposable 110 can be moved close enough to the slide 100 to allow flowing of the liquid 116 via capillary action. The opposable holder device 96 of FIG. 2 can release the opposable 110. The ends 140 can move towards the slide 100, as indicated by arrows 143a, 143b (collectively “143”). The capillary forces provided by the liquid 116 help flatten the opposable 110 and spread the liquid 116, as indicated by arrows 141a, 141b. As the unfilled gaps 136a, 136b are closed, the liquid 116 moves towards the ends 140. The liquid 116 can push occlusions (e.g., air pockets, air bubbles, contaminants, particulate, or other occlusions) outwardly away from the specimen 124. The liquid 116 can move outwardly until it reaches the edges of the opposable 110 and/or the edges of the slide 100. The liquid 116 can thus fill substantially the entire gap 128.

In contrast to conventional coverslippers that press an end of a coverslip against a microscope slide to move a mounting liquid, the liquid 116 of FIG. 2 can be spread without any physical contact between the slide 100 and the opposable 110. The entire opposable 110 can be kept spaced apart from the slide 100 throughout the spreading process. This prevents unwanted movement of the slide 100 and avoids many problems associated with contacting the slide.

In some embodiments, the opposable 110 spreads the liquid 116 without physically contacting the specimen 124 to avoid or minimize damage to the specimen 124. The thickness t_{L} of the liquid layer 116 of FIG. 3 can be larger than the thickness t_{S} of the specimen 124. Thus, the opposable 110 is kept away from the specimen 124 to avoid or minimize physical contact with the specimen 124, which may break adhesion between the specimen 124 and the slide 100. Capillary forces keep the opposable 110 in the flattened configuration to maintain contact between the liquid 116 and the specimen 124. Because the opposable 110 is free floating, it is free to drift along the slide 100 to facilitate repositioning.

FIG. 3 shows a section 165 of the opposable 110 above the mounting region 162. The section 165 keeps the thin layer 116 in contact with the specimen 124, even if the ends 140 are moved slightly upward. The opposable 110 can remain spaced apart from the slide 100 without any intermediate components (e.g., spacers) between the opposable 110 and the slide 100. If the opposable 110 is resilient and has a non-planar configuration in a relaxed state, the capillary forces can be sufficient to hold the opposable 110 in the illustrated flat configuration. Advantageously, the opposable 110 can be kept in the deflect flat configuration without damaging the specimen 124.

The liquid 116 can support at least a substantial portion of the mass of the floating opposable 110. The illustrated liquid 116 supports all of the mass of the opposable 110. As such, the entire opposable 110 can be spaced apart from the slide 100. In other embodiments, the liquid 116 supports at least 50% of the mass of the opposable 110. In various embodiments, the liquid 116 can support at least 60%, 70%, 80%, or 90%, or almost all of the mass of the opposable.

The platen 131 illustrated in FIG. 3 can be moved downwardly into contact with the opposable 110 to compress the specimen 124, agitate (e.g., mix) the liquid 116, or combinations thereof. Agitating the liquid 116 may enhance liquid uptake. In some protocols, the opposable 110 can float for one period, and the opposable 110 can be used to agitate the reagent for another period.

FIG. 3 also shows a release mechanism comprising push rods 190a, 190b (collectively “190”). If liquid becomes trapped between the platen 131 and the opposable 110, the rods 190 can overcome adhesion forces to separate the opposable 110 and the platen 131. Other types of release mechanisms can also be used, if needed or desired.

A user or an automated gripper can grab the end 140b and can pull the opposable 110 away from the slide 100. If the opposable 110 is resilient and has a relaxed non-planar configuration, it can return to its non-planar configuration when it is removed from the slide 100. The opposable 110 can be discarded or cleaned and reused. In other embodiments, the platen 131 removes the opposable 110. If the platen 131 is a pneumatic chuck, it can draw a vacuum to pick up and carry the opposable 110.

The method illustrated in FIGS. 1-3 can be used to perform different processing protocols. Processing protocols may require different liquid volumes in order to meet various processing criteria (e.g., chemical requirements, uptake requirements, solubility limitations, or the like). If the specimen 124 is a paraffin embedded specimen, a relatively small volume of de-waxing solution (e.g., 12 microliters of xylene) can be delivered on the upper surface 120, illustrated as a mounting surface. After dewaxing, a relatively large volume of reagent can be delivered on and spread along the upper surface 120. In some protocols, a volume of about 5 microliters to about 500 microliters of reagent (e.g., stain) is used. The opposable 110, or a new opposable, can apply the reagent to the specimen 124. Used opposables can be discarded. Any number of reagents can be sequentially applied to the specimen 124. In some embodiments, a single opposable is used to perform a staining protocol. The opposable can removed and discarded to prevent reagent carryover between specimens. In other embodiments, multiple opposables are used to perform a single protocol. For example, each opposable can be used to apply a different reagent to a single specimen.

The specimen 124 can include one or more tissue sections, cytological preparations, micro-arrays (e.g., micro-arrays of DNA, protein, or the like), tissue arrays, cells, or other types of biological specimens. A biological specimen can be any sample obtained from, derived from or containing any organism including a plant, an animal, a microbe or even a virus. Particular examples of biological specimens include tissue sections, cytology samples, sweat, tears, urine, feces, semen, pre-ejaculate, nipple aspirates, pus, sputum, blood, serum, tissue arrays, and protein and nucleic acid arrays. The illustrated specimen 124 is a single tissue section, such as an embedded tissue section (e.g., a paraffin embedded tissue section).

Samples can be processed with a wide range of substances, such as reagents, probes, rinses, and/or conditioners. The substances can be fluids (e.g., gases, liquids, or gas/liquid mixtures), or the like. The fluids can be solvents (e.g., polar solvents, non-polar solvents, etc.), solutions (e.g., aqueous solutions or other types of solutions), or the like. Liquids can contain additives, particles, or the like. Reagents include, without limitation, stains, wetting agents, antibodies (e.g., monoclonal antibodies, polyclonal antibodies, etc.), antigen recovery fluids (e.g., aqueous- or non-aqueous-based antigen retrieval solutions, antigen recovery buffers, etc.), or the like. Stains include, without limitation, dyes, hematoxylin stains, eosin stains, conjugates of antibodies or nucleic acids with detectable labels such as haptens, enzymes or fluorescent moieties, or other types of substances for imparting color and/or for enhancing contrast. In some embodiments, processing fluids in the form of reagents are applied to the samples. To reduce the volumes of liquids consumed during processing, concentrated liquids can be utilized. For example, concentrated reagents can be uniformly applied over samples with large surface areas to reduce processing costs and waste. A thin reagent film can be kept in contact with the sample to ensure enhanced uptake. Excessive volumes of reagents can be conveniently removed in a controlled manner.

FIG. 4 shows a slide processing apparatus 200 including a dispenser 202 with an outlet 204 positioned to output a substance between a slide 209 and an opposable 210. A slide holder 212 holds the slide 209 at an inclined orientation. A dispensed substance 214 is trapped at a narrowed region 217 of a gap 216. An opposable holder device 219 can selectively move an upper end 222 of the opposable 210 to increase or decrease the length or surface area of the opposable 210 contacting the substance 214.

The opposable holder device 219 includes a platen 221 and a tensioner 223. A retainer 234 can hold a retained end 232 of the opposable 210. The end 232 can be slid into a slot of the retainer 234 to load the opposable 210. In other embodiments, the end 232 is inserted into a retaining feature (e.g., a groove, a channel, or other feature) of the platen 221. In yet other embodiments, an adhesive couples the opposable 210 to the platen 221. The adhesive can be a pressure-sensitive adhesive or other type of suitable adhesive.

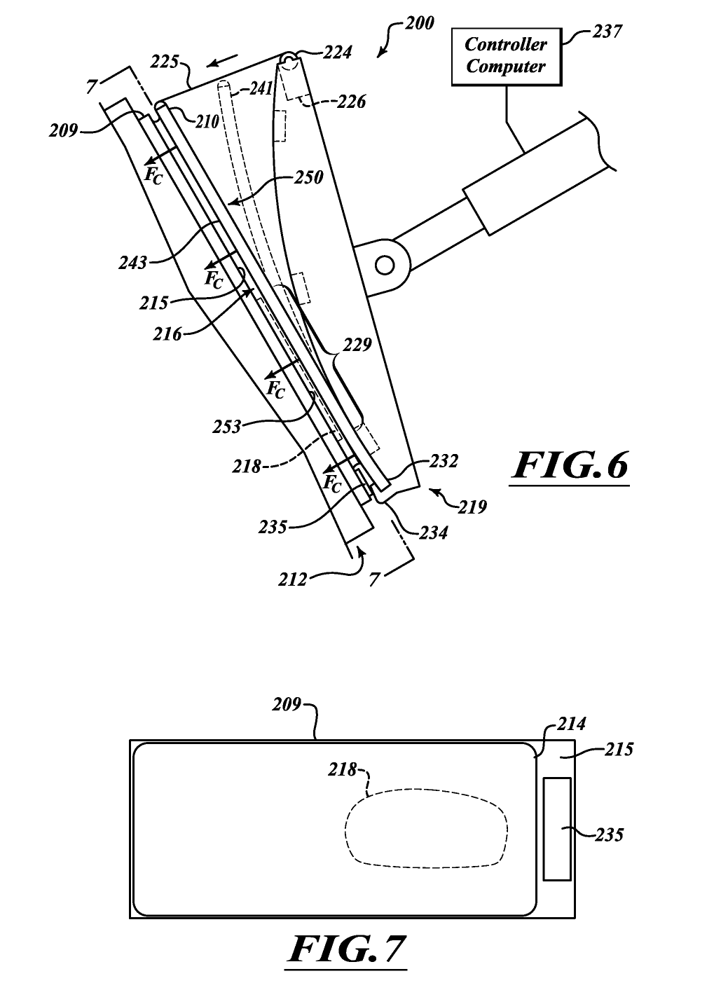

The tensioner 223 can have a first state for contacting the liquid 214 with the opposable 110 (shown in FIG. 4) and a second state for spreading the liquid 214 (shown in FIG. 6). The tensioner 223 includes a roller 224, a tether 225, and a puller unit 226 (illustrated in dashed line). The tether 225 is coupled to the end 222 of the opposable 210 and extends about the roller 224 to the puller unit 226. In some embodiments, the tether 225 is connected to a hook that passes through an opening (e.g., a through-hole, an aperture, or the like) in the end 222. The tether 225 can be one or more filaments, cables, wires, or other type of flexible member that can apply forces to the opposable 110.

The puller unit 226 can include one or more motors (e.g., drive motors). The tether 225 can be wound about a spool, a spindle, or other component of the puller unit 226. The puller unit 226 can also include a power supply, such as a battery or energy storage device. The puller unit 226 can pull the opposable 210 against the platen 221.

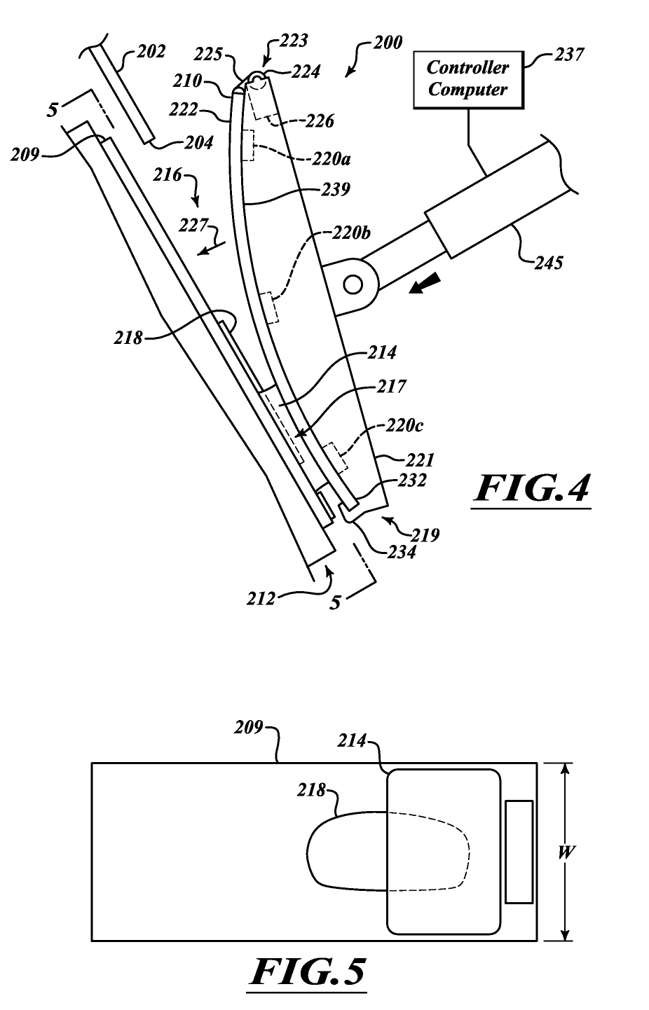

The dispenser 202 can include, without limitation, one or more fluid containers, pumps, filters, valves, thermal elements (e.g., heaters, coolers, etc.), controllers, or the like and can output a wide range of substances, including mounting media, reagents, or other processing substances. In some embodiments, the dispenser 202 includes one or more thermo-electric elements for controlling the temperature of the outputted substance. The substance can be heated before dispensing to adjust the viscosity, spreadability, or other characteristics of the substance. The viscosity of the illustrated liquid 214 can be increased or decreased to help spread the liquid 214 across the width of the slide 209, as shown in FIG. 5. Of course, an additional volume of liquid can be delivered into the gap 216, if needed or desired. For example, liquid can be added if the liquid 214 does not extend across most or substantially all of the width w of the slide 209.

A controller 237 of FIG. 4 can be in communication with the puller unit 226, elements 220a-220c, and/or other components. The controller 237 can generally include, without limitation, one or more computers, central processing units, processing devices, microprocessors, digital signal processors, central processing units, processing devices, microprocessors, digital signal processors (DSP), application-specific integrated circuits (ASIC), readers, and the like. To store information, the controller 237 can include, without limitation, one or more storage elements, such as volatile memory, non-volatile memory, read-only memory (ROM), random access memory (RAM), or the like. The stored information can include optimization programs, tissue preparation programs, calibration programs, or other executable programs. The controller 237 can execute optimization programs to optimize performance (e.g., reduce excess reagent consumption, reduce processing time, increase productivity, improve processing consistency, or the like). The controller 237 can be communicatively coupled to an actuator 245, dispenser 202, tensioner 223, puller unit 226, or any other component.

To spread the liquid 214, the tether 225 of FIG. 4 can be extended. The end 222 of the curved opposable 210 moves away from a retained position 239 towards the slide 209. FIG. 6 shows an intermediate position 241 (illustrated in dashed line) between the retained position 239 of FIG. 4 and a floating position 243 of FIG. 6. As the opposable 210 flattens, the surface area of the opposable 210 in contact with the liquid 214 gradually increases. The retained end 232 is adjacent to a floating section 250 and extends into the retainer 234. The retainer 234 can be spaced apart from the liquid 214 to prevent wicking between the retainer 234 and the end 232. Capillary forces F_{c} may equilibrate to ensure that most of the flattened opposable 210 is generally parallel to the slide 209. Because the opposable 210 is held in a cantilever fashion, the floating section 250 is free to move towards or away from the slide 209 in response to changes in the capillary forces. Thus, the opposable 210, or at least a section 229 overlaying a mounting region 253, is held in a substantially flat configuration. Of course, the retainer 234 can release the end 232 such that the liquid 214 supports the entire opposable 210.

In certain embodiments, the retainer 234 can include a reader or other the device to obtain information from a label 235 of the slide 209. The reader can be communicatively coupled to the controller 237. The controller 237 can select a protocol based, at least in part, on information obtained from the label 235.

FIG. 7 shows the thin liquid layer 214 on an upper surface 215 of the slide 209. Even if the specimen 218 migrates along the upper surface 215, the specimen 218 remains in contact with the liquid 214 throughout processing. The specimen 218 is thus processed without utilizing high precision positioning/alignment control devices that may be prone to errors, require recalibration, and other complicated moving components that are subject to various problems. Different forces, such as gravity, capillary forces, a pressure change (e.g., a reduced pressure such as a vacuum), pressure applied to the back surface of the opposable, or combinations thereof can be used to move and/or remove the liquid.

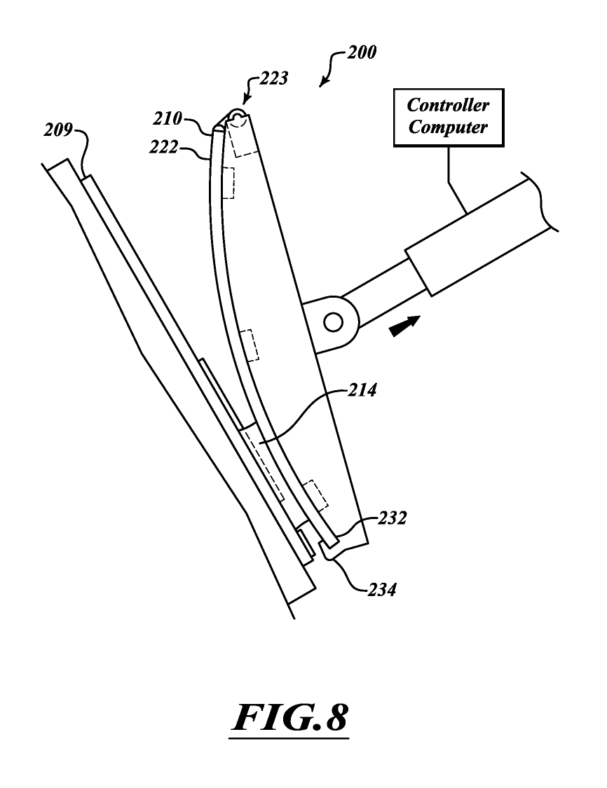

Referring to FIGS. 6 and 8, the tensioner 223 can pull the end 222 contacting the liquid 214 away from the slide 209 to drive the liquid back to its initial position. FIG. 8 shows the opposable 210 returned to its initial position and the liquid 214 accumulated proximate the end 232. Of course, the opposable 210 can be used to repeatedly move the liquid 214 back and forth across the specimen 218, if needed or desired.

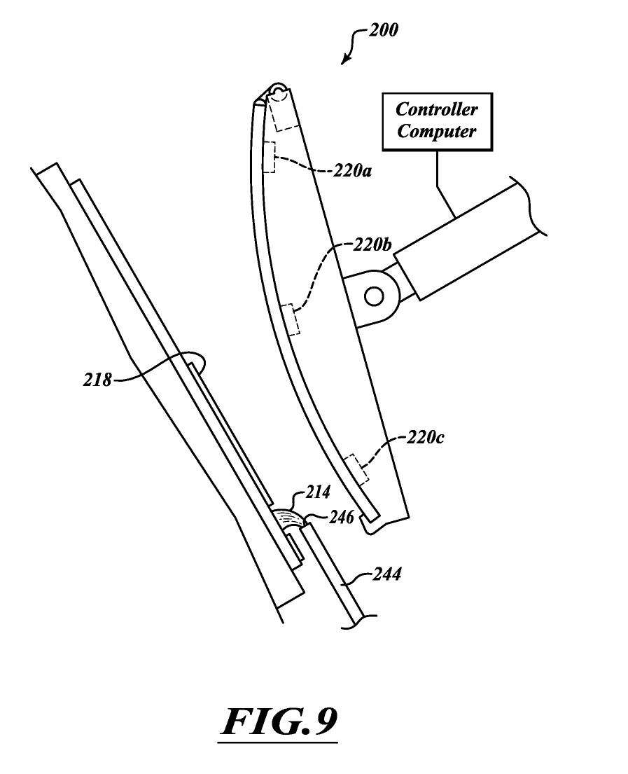

Referring to FIG. 9, a removal system 244 can be moved proximate to the liquid 214. The liquid 214 can be drawn through an inlet 246 of the removal system 244 via a vacuum. The removal system 244 can include one or more pressurization devices (e.g., pumps, vacuum apparatuses, or the like) to draw the vacuum. To provide convenient access to the liquid 214, the platen 221 can be moved away from the slide 209, as shown in FIG. 9.

To coverslip the slide 209 of FIG. 9, the opposable 210 can be a coverslip. An adhesive in a liquid state can be delivered onto the slide 209 after preparing the specimen 218. The adhesive can include, without limitation, thermosetting materials, epoxy, or other curable or selectively hardening adhesives, as well as thermoplastics. A thermosetting material can be a plastic that becomes permanently hardened when set. In some embodiments, the thermosetting material is cured using thermal energy, light energy, chemical activation, or the like. In some non-limiting embodiments, the adhesive comprises silicone, urethane resin, blends, or the like. The adhesive can fixedly couple the opposable 210 to the slide 209 to form a permanent mount slide, thereby increasing the useful life of the slide, protecting the specimen 218 from environmental changes, and/or protecting against accidental movement of the coverslip.

If the adhesive is light curable (e.g., ultraviolet curable or visible light curable), the elements 220a-220c (shown in dashed line in FIG. 9) can be light sources capable of converting electrical energy to optical energy. The elements 220 can include, without limitation, one or more light emitting diodes, optical filters, optical fibers, scattering mediums, or other optical components that can be used to obtain a desired light distribution. Light can be distributed evenly or unevenly. If UV curable adhesive is used to coverslip the slide 209, the elements 220 can be UV light sources. The elements 220 can also be other types of light sources used before, during, or after processing of the specimen 218 and/or during coverslipping.

The opposable 210 can be transparent or semi-transparent to allow propagation of light to the adhesive. The controller 237 can control the illumination sequence. For rapid mounting, the adhesive can be cured in less than about 5 minutes, 60 seconds, 20 seconds, or 10 seconds. Other curing times are also possible, if needed or desired. Alternatively, the opposable 210 can also be a coverslip can be deposited on the slide 209 without using any adhesive. In some embodiments, the opposable 210 is a coverslip used to form a wet mount slide. The dispenser 202 of FIG. 4 can output the water used for wet mounting.

Referring to FIGS. 4-9, the elements 220a-220c (collectively “220”) can be in the form of thermo-electric elements adapted to convert electrical energy to thermal energy. The thermo-electric elements 220 can support different protocols that require thermal cycling, even rapid thermal cycling for ISH, IHC, or the like. When the elements 220 generate heat, heat is transferred to the opposable 210. Heat is ultimately transferred to the specimen(s) and processing liquid 214. The amount of electrical energy delivered to the elements 220 can be increased or decreased to increase or decrease the temperature of the specimen(s) and processing liquid.

The elements 220 can also be resistive heating elements. A wide range of different types of resistive heating elements (e.g., plate resistive heaters, coil resistive heaters, strip heaters, or the like) can be selected based on the desired operating parameters. Other types of thermal elements, such as cooling elements, heating/cooling elements, or the like, can be utilized. As used herein, the term “cooling element” is a broad term that includes, without limitation, one or more elements capable of actively absorbing heat so as to effectively cool at least a portion of the opposable 210. For example, a cooling element can be a cooling tube or channel through which a chilled fluid flows. In some embodiments, the elements 220 can produce heat for a heating period and other elements 220 can absorb heat for a cooling period.

In some embodiments, the elements 220 are heating/cooling elements, such as Peltier devices. Peltier devices may be solid state components which become hot on one side and cool on an opposing side, depending on a direction of current passed therethrough. By simply selecting the direction of current, the Peltier device can be employed to heat the opposable 210 for a desired length of time. By switching the direction of the current, the elements 220 cool the opposable 210. In other embodiments, the heating/cooling elements 220 can be in the form of channels through which a working fluid flows. Heated fluid can be passed through the channels for a heating period, and a chilled fluid can be passed through the channels for a cooling period. The position, number, and type of heating/cooling elements 220 can be selected based on the desired temperature profile of the platen 221.

The processing apparatus 200 is capable of moving the slide 209 and the opposable 210 to different orientations, including an inclined orientation (FIG. 4), generally vertical orientation, generally horizontal orientation, or the like. To facilitate downward movement of a dispensed liquid due to gravity, the slide 209 can be at an inclined orientation or generally vertical orientation. In some protocols, fluid is both dispensed and removed when the slide 209 is in a generally vertical orientation. During processing, the slide 209 can be at a generally horizontal orientation to help position (e.g., self-align, self-gap, etc.) the opposable 210. The slide 209 and the opposable 210 can be rotated at different times during a particular protocol for increased processing flexibility.

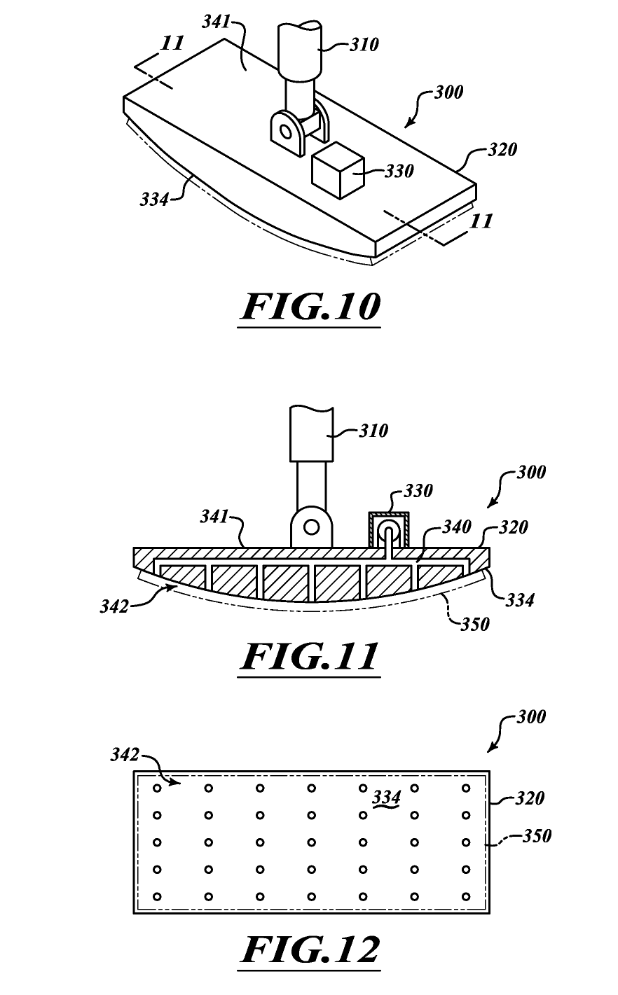

FIGS. 10 and 11 show an opposable holder device 300 including an actuator 310 and a platen 320. A pressurization device 330 is coupled to the platen 320. To hold an opposable against a lower surface 334, the pressurization device 330 can draw a vacuum through a network of passageways 340 formed in a body 341 of the platen 320.

FIG. 11 shows the passageways 340 extending from the pressurization device 330 to an array of openings 342. Suction drawn via the openings 342 holds an opposable 350 (illustrated in dashed line) against the surface 334. The suction can be reduced or substantially eliminated to release the opposable 350. A positive pressure can be generated by the pressurization device 330 to push the opposable 350 away from the platen 320.

The pressurization device 330 can be a pump capable of providing negative pressure, positive pressure, or both. In some embodiments, the pressurization device 330 is not mounted on the platen 320. Such a pressurization device can be fluidically coupled to the platen 320 via one or more lines that extend along the actuator 310.

FIG. 12 shows generally evenly spaced apart openings 342 that form a grid pattern. The size, pattern, and dimensions of the openings can be selected based on the size, properties (e.g., mass, flexibility, etc.), and configuration of the opposable 350. For example, the openings can be unevenly spaced from one another if the opposable 350 has varying mechanical properties or dimensions along its length.

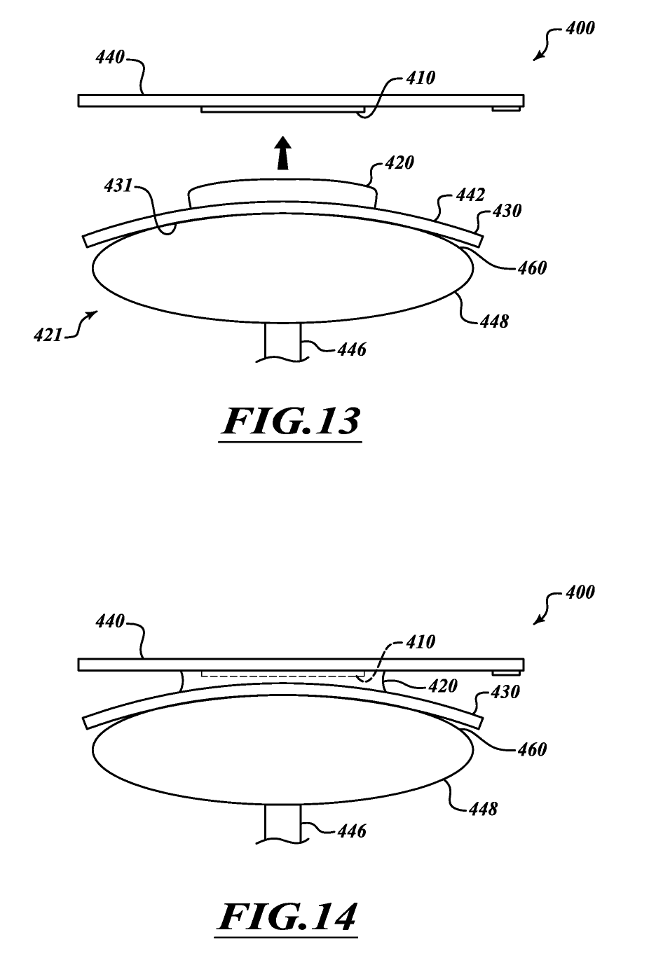

FIGS. 13-15 shows a slide processing apparatus 400 for processing a specimen 410 using a substance 420 carried on an opposable 430. The substance 420 can be easily spread along a surface 442 of the opposable 430 resting on an upper surface 460 of a platen 448.

The opposable 430 of FIG. 13 can be pre-curved so the user can conveniently place a concave surface 431 of the opposable 430 on the convex surface 460 of the platen 448. The complimentary geometry may help prevent, inhibit, or limit relative movement between the opposable 430 and the platen 448. In other embodiments, the opposable 430 is drapable and conforms to the shape of the platen 448. A user can manually place the drapable opposable 430 on the platen 448.

An actuator 446 can move the platen 448 towards a slide 440 to bring the substance 420 into contact with the specimen 410 and/or the slide 440. FIG. 14 shows the substance 420 contained between the opposable 430 and the slide 440. Capillary forces provided by the substance 420 pull the opposable 430 away from the platen 448 towards the slide 440. In this manner, the substance 420 can flatten the opposable 430.

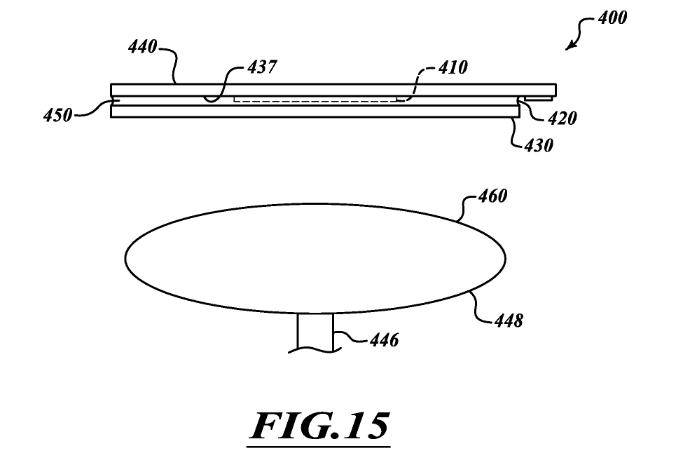

FIG. 15 shows the opposable 430 after the substance 420 has spread along a gap 450. Even though a mounting surface 437 of the slide 440 faces downwardly, the substance 420 can securely hold the opposable 430. The substance 420 thus supports all of the mass of the opposable 430 via surface tension. The user can manually remove the opposable 430 when desired. Alternatively, the platen 448 can pull the opposable 430 away from the slide 440.

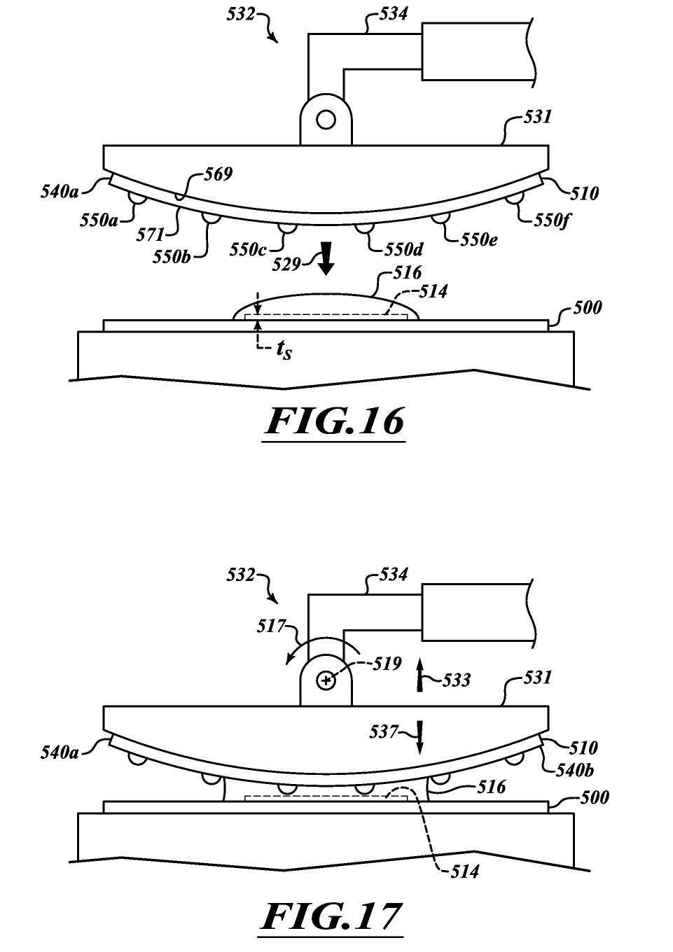

A wide range of different techniques can be used to move processing fluids. FIGS. 16-20 show a method of moving a fluid utilizing a rolling motion. Generally, a roller mechanism 532 rolls an opposable 510 along a slide 500. An actuator 534 of the roller mechanism 532 moves a platen 531 to contact a fluid 516 with the opposable 510. The platen 531 is rolled back and forth to move the fluid 516 with respect to a specimen 514.

FIG. 16 shows the opposable 510 spaced apart from the fluid 516, which surrounds and contacts the specimen 514. In other embodiments, the fluid 516 is spaced apart from the specimen 514 before processing. Thus, the fluid 516 can be positioned at various locations along the slide 500. The actuator 534 moves the platen 531 downwardly, as indicated by an arrow 529, to contact an upper surface of the fluid 516 with the opposable 510.

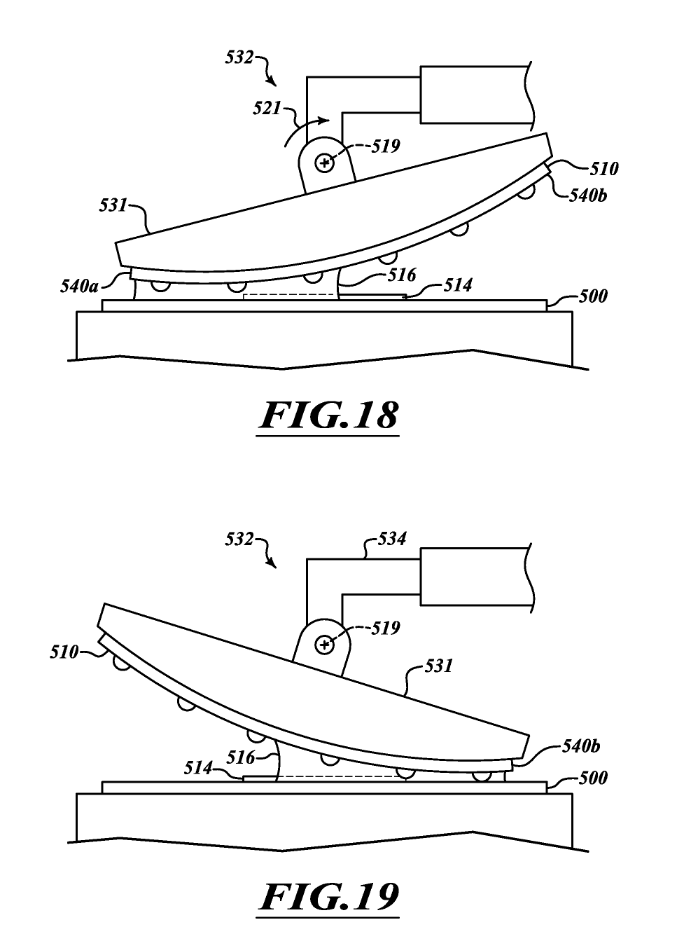

Referring to FIG. 17, the platen 531 is rotated counterclockwise, as indicated by an arrow 517, about an axis of rotation 519 to bring an opposable end 540a closer to the slide 500. As the end 540a is moved downwardly, the fluid 516 moves towards the end 540a. FIG. 18 shows the fluid 516 accumulated between the end 540a and the slide 500.

The platen 531 of FIG. 18 can then be rotated clockwise, as indicated by an arrow 521, to move an opposing end 540b towards the slide 500. FIG. 19 shows the end 540b proximate to the slide 500. The fluid 516 is accumulated between the end 540b and the slide 500. In this manner, the platen 531 can be rolled to move the fluid 516 along the slide 500 and across at least a portion of the specimen 514. In some processing protocols, the fluid 516 is repeatedly moved across the entire specimen 514 by rolling the platen 531.

In some embodiments, including the illustrated embodiment of FIGS. 18 and 19, the opposable 510 is spaced apart from the slide 500 while the platen 531 is rolled along an imaginary plane that is spaced apart from and generally parallel to the slide 500. In other embodiments, the opposable 510 physically contacts the slide 500 and/or the specimen 514 as the platen 531 is rolled. Such a rolling motion can be used to manipulate the fluid 516. Manipulating fluids can include, without limitation, spreading, agitating, or otherwise moving or displacing fluids. A first processing sequence of a protocol, for example, may include rolling the opposable 510 to move a bolus of fluid. Another sequence of the protocol can include both rolling and vibrating the opposable 510 to agitate the moving fluid.

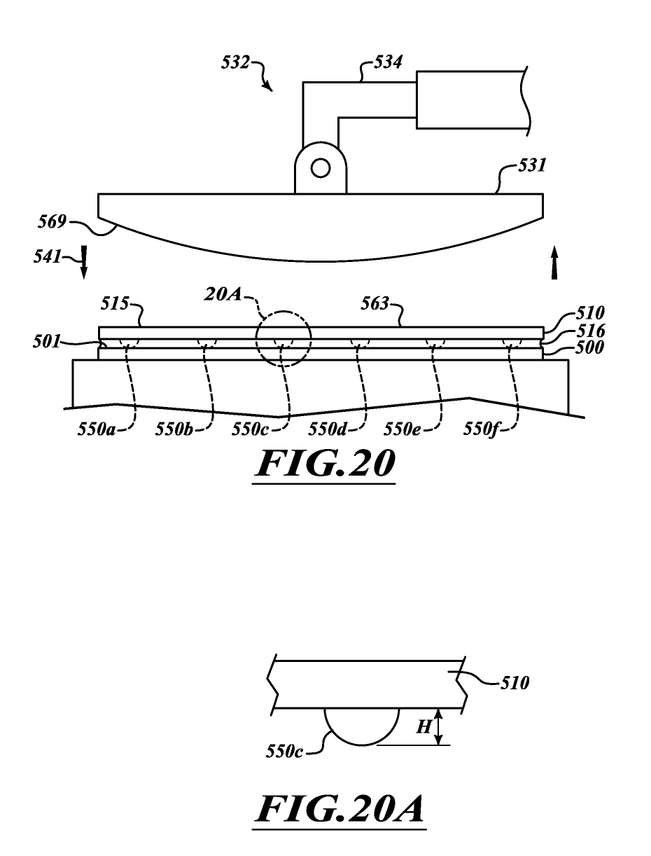

The opposable 510 can be released and separated from the platen 531. The released opposable 510 can float on the fluid 516, as shown in FIG. 20. Gapping elements 550a-550f (collectively “550”) can contact or be spaced apart from the slide 500, depending on the volume of fluid 516. If the volume of fluid 516 is sufficiently high, the gapping elements 550 may be spaced from an upper surface 501 of the slide 500. For relatively low volumes of fluid 516, the gapping elements 550 can contact the slide 510 and maintain a desired capillary gap. A central region 563 can float gently on the fluid 516. Advantageously, processing can be performed with a minimal volume of fluid 516 because of the precisely controlled height of the capillary gap.

To pick up the opposable 510 of FIG. 20, the platen 531 can move downwardly, as indicated by an arrow 541, and into contact with the opposable 510. The platen 531 can then retain the opposable 510 against its lower surface 569 and transport the opposable 510 to a disposal container or other suitable location.

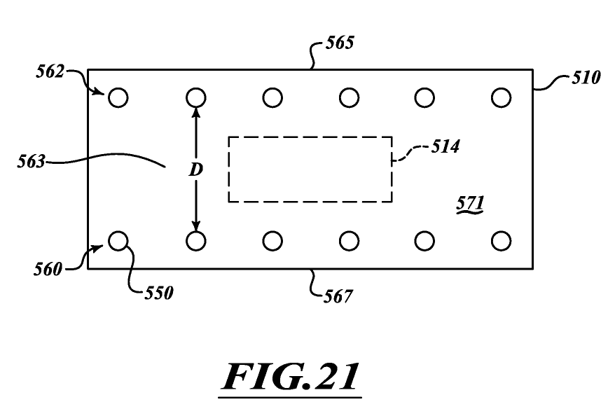

Referring to FIG. 21, the gapping elements 550 are spaced apart from the edges 565, 567 to keep the fluid 516 proximate to the contact region 563. Advantageously, the fluid 516 can be kept far enough away from the edges 565, 567 to prevent wicking out from underneath the opposable 510, even if another object contacts the edges 565, 567.

FIG. 21 also shows a first row 560 of gapping elements 550, a second row 562 of gapping elements 550, and the contact region 563 therebetween. The rows 560, 562 extend longitudinally along a length of the opposable 510. Opposing gapping elements of each row 560, 562 are generally laterally aligned. If the opposable 510 contacts the slide 500 during a rolling or flattening process, laterally aligned gapping elements 550 can be successively brought into contact with the slide 500. Each of the rows 560, 562 can be generally similar to one another. Accordingly, the description of one of the rows 560, 562 applies equally to the other, unless indicated otherwise.

The row 560 can include about 4 to about 60 gapping elements with an average distance between adjacent gapping elements in a range of about 0.05 inch (1.27 mm) to about 0.6 inch (15.24 mm). In some embodiments, including the illustrated embodiment, the row 560 includes 6 gapping elements. As viewed from below (see FIG. 21), the row 560 has a generally linear configuration. In other embodiments, the row 560 has a zigzag configuration, a serpentine configuration, or other configuration or pattern. The gapping elements in the row 560 can be evenly or unevenly spaced from one another. The spacing distance can be greater than the height of at least one of the gapping elements and/or less than a thickness of the opposable. Other spacings are also possible, if needed or desired.

A distance D between the rows 560, 562 can be selected based on the dimensions of the specimen 514 (illustrated in phantom) and/or the dimensions of the slide 500. In some embodiments, the distance D is in a range of about 0.25 inch (6.35 mm) to about 1 inch (25 mm). If the slide 500 is a standard microscope slide, the distance D can be less than about 0.9 inch (23 mm). If the opposable 510 is centered on the slide 500, the gapping elements 550 can be positioned within or proximate to a 1 mm border of the slide 500, thus mitigating the risk of damage to the specimen. The gapping elements 550 may provide contactless treatment of the specimen 514 if the gap is larger than the thickness of the specimen 514 (e.g., 4 microns nominally for tissue sections, and often up to 10 microns) and/or if the gapping elements 550 are positioned proximate to the slide edges (e.g., within about 1 mm of the slide edges). The heights H (FIG. 20A) of the gapping elements 550 can be selected based on the capillary behavior of the liquid 516. Such embodiments can have heights H that are less than about 0.007 inch (0.18 mm). For example, the gapping elements 550 can have heights H of about 0.003 inch (0.08 mm). In other embodiments, the heights of the gapping elements 550 can be equal to or greater than a thickness tₛ (FIG. 16) of the sample 514 to maintain a capillary gap suitable for maintaining a thin film without damaging the specimen 514. In other embodiments, the heights of the gapping elements 550 are approximately equal to or slightly less than a thickness of the sample 514 to slightly compress the sample 514, preferably without damaging the sample 514. By way of example, the height H (FIG. 20A) can be equal to or less than about 0.015 inch (0.38 mm) if the specimen is a tissue section with a thickness that is less than about 0.015 inch (0.38 mm). In some embodiments, the height H is in a range of about 0.001 inch (0.025 mm) to about 0.005 inch (0.127 mm). In certain embodiments, the height H is about 0.003 inch (0.076 mm) to process thin tissue sections with a thickness less than about 30 microns, 20 microns, or 10 microns.

The illustrated gapping elements 550 are substantially partially spherical dimples, which are especially well suited for slidably contacting the slide 500 without damaging (e.g., marring or scratching) the slide 500. If the specimen 514 is sufficiently large or moves towards one edge of the slide 500, the spherical dimples 550 can slide over the specimen 514 without damaging or dislodging the specimen 514. In various embodiments, the gapping elements can be partially hemispherical or partially elliptical dimples, as well as polyhedron protrusions, conical protrusions, frustoconical protrusions, or a combination of polygonal and arcuate shapes. In yet other embodiments, the gapping element can include, without limitation, one or more positioners, rails, or other structural features capable of serving as spacers. In one embodiment, an opposable includes one or more rails (e.g., straight rails, arcuate rails, or the like) configured to bear against an upper surface of a slide. In yet other embodiments, gapping elements may be separate components positionable between an opposable and a microscope slide.

Referring again to FIG. 17, the fluid 516 can be agitated. The platen 531 can move upwardly, as indicated by an arrow 533, and downwardly, as indicated by an arrow 537, to agitate the fluid 516. Thus, a combination of a rolling action and displacement of the opposable 510 can be utilized. In yet other embodiments, the platen 531 can repeatedly contact the opposable 510 to agitate the fluid 516. For example, the platen 531 of FIG. 20 can be moved into contact with a back surface 515 of the opposable 510. The applied forces can cause mixing of the fluid 516. The platen 531 can be repeatedly raised and lowered to agitate the fluid 516.

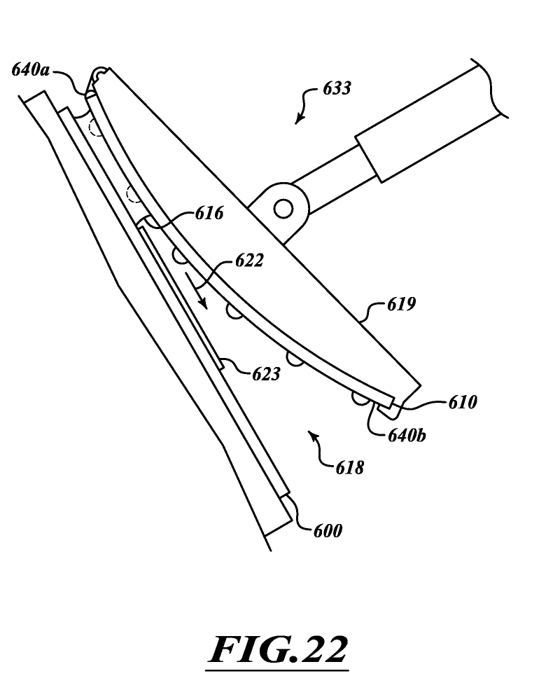

FIGS. 22-24 show one method of spreading a liquid 616 by rolling the opposable 610 using a roller mechanism 633. FIG. 22 shows an opposable holder device 619 of the roller mechanism 633 positioning an opposable end 640a proximate to a slide 600. The opposable holder device 619 can be rolled with respect to the slide 600 to move the liquid 616 in a direction indicated by an arrow 622. The liquid 616 moves along a gap 618 as an opposable end 640b is moved towards the slide 600.

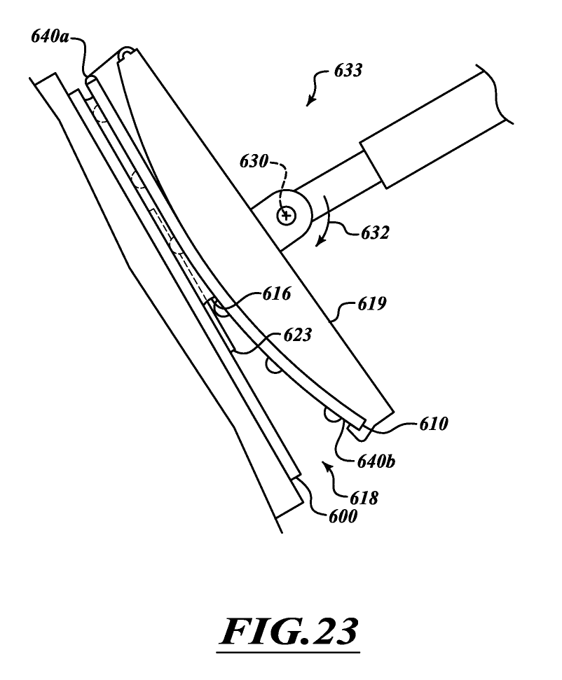

FIG. 23 shows the opposable holder device 619 in an intermediate position such that about half of the length of the opposable 610 is generally parallel to the slide 600 and floating on the liquid 616. Half of the opposable 610 is thus in a generally planar configuration. The opposable holder device 619 can continue to rotate about an axis of rotation 630, as indicated by an arrow 632, to bring substantially the entire opposable 610 into a parallel relationship with the slide 600.

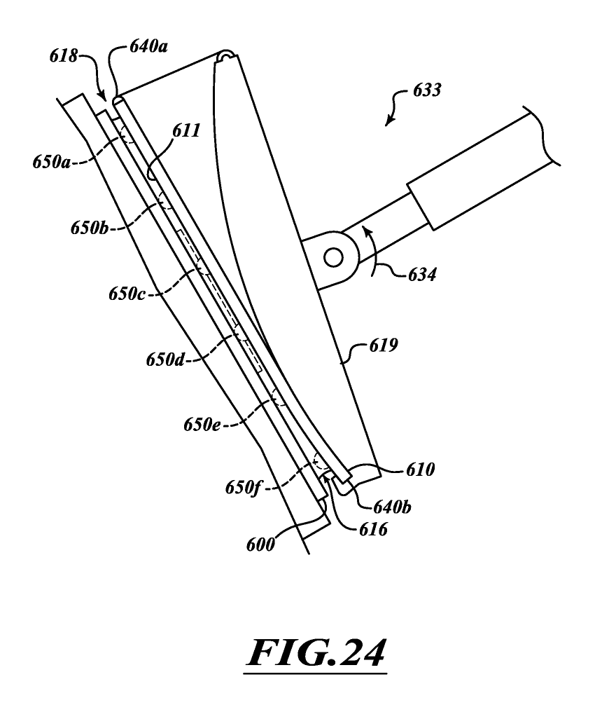

FIG. 24 shows the entire opposable 610 floating on the liquid 616. The opposable holder device 619 can be rotated counterclockwise, as indicated by an arrow 634, to pull the end 640b away from the slide 600. The opposable 610 and the liquid 616 can be returned to the initial positions illustrated in FIG. 22.

The rolling process of FIGS. 22-24 can be repeated any number of times to move the liquid 616 across the slide 600 and/or the specimen 623. In some embodiments, the opposable holder device 619 is repeated rolled to move the ends 640a, 6400b away from and towards the slide 600. For example, the end 640a of FIG. 24 can be pulled against the opposable holder device 619 to move the fluid 616 towards the end 640b. Of course, the opposable 610 can be held against the opposable holder device 619 as the holder device 619 is rolled to move the bolus of fluid 616 along the slide 600. Thus, a wide range of different types of techniques can be utilized to manipulate the fluid 616.

To prevent pushing the liquid 616 out of the capillary gap 618, gapping elements 650a-f can keep a surface 611 of the opposable 610 from moving too close to the slide 600. In other embodiments, gapping elements can be provided on a slide. For example, gapping elements can be temporarily or permanently coupled to the slide 600.

The opposables disclosed herein can also have a relatively large number of gapping elements, rows of gapping elements, etc. to distribute the contacting load so as to minimize or limit loading (e.g., pressure point loading) to the specimen. Such embodiments may have gapping elements positioned to contact the specimen during use.

The embodiments, features, systems, devices, materials, methods and techniques described herein may, in some embodiments, be similar to any one or more of the embodiments, features, systems, devices, materials, methods and techniques described in U.S. Provisional App. No. 61/261,267 filed Nov. 11, 2009 and U.S. Provisional App. No. 61/222,046 filed Jun. 30, 2009. In addition, the embodiments, features, systems, devices, materials, methods and techniques described herein may, in certain embodiments, be applied to or used in connection with any one or more of the embodiments, features, systems, devices, materials, methods and techniques disclosed in U.S. Provisional App. No. 61/261,267 and U.S. Provisional App. No. 61/222,046. The slide processing apparatuses discussed in connection with FIGS. 1-15 can thus be incorporated into the embodiments disclosed in U.S. Provisional App. No. 61/261,267 and U.S. Provisional App. No. 61/222,046. For example, the slide processing apparatuses can serve as staining instruments used with components, systems, and techniques disclosed in U.S. Provisional App. No. 61/261,267 and Provisional App. No. 61/222,046. U.S. Provisional App. No. 61/261,267 and Provisional App. No. 61/222,046 are hereby incorporated by reference in their entireties.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method of applying a liquid to a specimen on a slide, the method comprising:
holding an opposable in a non-planar configuration using an opposable holder device;
contacting the liquid with a surface of the slide and with the opposable held by the opposable holder device by moving the opposable towards the slide;
allowing the liquid contacting the opposable to move at least a portion of the opposable away from the non-planar configuration towards a substantially planar configuration to spread the liquid; and
floating the portion of the opposable on the spread liquid to keep the liquid spread along a gap between the portion of the opposable and the surface of the slide.

2. The method of claim 1, further comprising contacting substantially all of a section of the opposable overlaying a mounting region of the slide with the spread liquid.

3. The method of claim 1, further comprising freely floating the portion of the opposable on the liquid such that the spread liquid separates a mounting area of the slide and a section of a surface of the opposable covering the mounting area.

4. The method of claim 1, further comprising holding the opposable in the substantially planar configuration using capillary forces provided by the spread liquid.

5. The method of claim 1, further comprising agitating the liquid by moving the opposable held by the opposable holder device while the opposable contacts the liquid.

6. The method of claim 1, wherein holding the opposable in the non-planar configuration comprises holding the opposable in a curved configuration.

7. The method of claim 1, further comprising physically coupling an end of the opposable to the opposable holder device, the end is adjacent to the portion of the opposable that floats on the liquid.

8. The method of claim 1, further comprising holding the opposable in a cantilever fashion using the opposable holder device to float the portion of the opposable on the spread liquid.

9. The method of claim 1, further comprising contacting the surface of the slide with a plurality of gapping elements that protrude from a surface of the opposable to form the gap.

10. The method of claim 9, wherein at least one of the gapping elements has a height of at least about 0.001 inch.

11. The method of claim 1, further comprising spacing at least one gapping element of the opposable from the surface of the slide while the portion of the opposable floats on the spread liquid, the opposable having a plurality of spaced apart gapping elements extending from a surface of the opposable.

12. A method, comprising:
contacting a liquid with a resilient opposable and a slide carrying a specimen while the resilient opposable is in a non-planar configuration;
floating at least a portion of the resilient opposable in the non-planar configuration on the liquid;
flattening the floating portion of the resilient opposable using forces provided by the liquid;
spreading the liquid along the slide as the portion of the resilient opposable is flattened; and
removing the resilient opposable from the slide such that the resilient opposable returns to the non-planar configuration.

13. The method of claim 12, further comprising holding the opposable using an opposable holder device while the liquid is spread along a mounting surface of the slide.

14. The method of claim 12, further comprising floating a first end of the opposable on the spread liquid while holding a second end of the opposable using an opposable holder device.

15. The method of claim 14, further comprising:
rolling at least a portion of the opposable along the slide to overlay the slide with the first end while the second end is held by the opposable holder device.

16. The method of claim 12, further comprising agitating the liquid while the opposable is held in the non-planar configuration, wherein the non-planar configuration is an arcuate configuration.

17. The method of claim 12, further comprising floating the portion of the opposable on the liquid to cause a surface of the portion to be substantially parallel to a mounting surface of the slide.

18. A method, comprising:
contacting a liquid with an opposable and a slide carrying a specimen while at least a portion of the opposable is spaced apart from the liquid;
floating a first portion of the opposable on the liquid; and
rolling a second portion of the opposable using a roller mechanism to flatten the second portion to spread the liquid.

19. The method of claim 18, further comprising retaining the second portion of the opposable with the roller mechanism while rotating a platen of the roller mechanism that carries the opposable.

20. The method of claim 18, further comprising keeping a substantial portion of the opposable spaced apart from the slide using a plurality of gapping elements spaced apart from one another, the plurality of gapping elements protrude from a surface of the opposable facing the slide.

21. An apparatus, comprising:
a slide holder; and
an opposable holder device configured to hold an opposable, the opposable holder device having a first state and a second state, the opposable holder device in the first state holds the opposable in a non-planar configuration while the opposable is spaced apart from a slide held by the slide holder, the opposable holder device in the second state contacts at least a portion of the opposable and the slide held by the slide holder with a liquid to float the portion of the opposable on the liquid.

22. The apparatus of claim 21, wherein the opposable holder device includes:
a platen; and
a tensioner that pulls the opposable against the platen to hold the opposable in the non-planar configuration, the tensioner allows the opposable in the non-planar configuration to move towards a flattened configuration to float the portion of the opposable on the liquid.

23. The apparatus of claim 21, wherein the opposable holder device is movable away from the opposable floating on the liquid.

24. The apparatus of claim 21, wherein the opposable holder device is configured to move the opposable with respect to the slide to agitate the liquid.

25. The apparatus of claim 21, wherein the opposable holder device is configured to release the opposable to float the opposable on the liquid.

26. The apparatus of claim 21, wherein the opposable holder device comprises:
an actuator;
a platen coupled to the actuator, the platen holds the opposable in the non-planar configuration as the actuator moves the opposable into contact with the liquid; and
a release mechanism that releases the portion of the opposable.

27. The apparatus of claim 26, wherein the actuator is configured to roll the platen along or proximate to the slide to move the liquid along a capillary gap between the opposable and the slide.

28. An apparatus, comprising:
a slide holder; and
an opposable holder device that holds an opposable in a non-planar configuration, in a first state of operation the opposable holder device moves towards the slide holder to contact a liquid with a surface of a slide held by the slide holder and with the opposable held by the opposable holder device, in a second state of operation the opposable holder device allows the liquid contacting the opposable to move at least a portion of the opposable away from the non-planar configuration towards a substantially planar configuration as the liquid spreads along the slide.

29. The apparatus of claim 28, wherein the opposable holder device includes a retainer that receives and holds the opposable.

30. The apparatus of claim 28, wherein the opposable holder device includes a platen and an actuator that moves the platen with respect to the slide holder.

31. The apparatus of claim 28, further comprising:
a dispenser positioned to output the liquid onto the slide held by the slide holder or the opposable held by the opposable holder device.

32. The apparatus of claim 28, further comprising:
a controller communicatively coupled to the opposable holder device, the controller sends signals to the opposable holder device to have the opposable holder device move the opposable towards the slide to spread the liquid without deforming the opposable due to physical contact between the slide and the opposable.

33. The apparatus of claim 28, further comprising:
at least one thermal element carried by the opposable holder device, the thermal element positioned to deliver thermal energy to the opposable to control a temperature of the liquid.

34. The apparatus of claim 28, further comprising:
an opposable that is held by the opposable holder device, the opposable including a first face, a second face opposing the first face, and a plurality of gapping elements protruding from the first face, the second face contacting the opposable holder device.

35. The apparatus of claim 34, wherein the plurality of gapping elements are dimensioned to define a capillary gap between the slide and the opposable when the opposable overlays the slide.

36. A method, comprising:
contacting a liquid on a slide with an opposable carried by a roller mechanism;
rolling the opposable with respect to the slide to spread the liquid;
allowing the opposable to move from a first configuration to a second configuration using the liquid; and
floating at least a portion of the opposable in the second configuration on the liquid.

37. The method of claim 36, further comprising contacting the slide with the opposable while the opposable is rolled along the slide.
